(19) United States
(12) Patent Application Publication
(10) Pub. No.: US 2010/0080601 A1
(43) Pub. Date: Apr. 1, 2010

(54) Image Forming Apparatus

(75) Inventor: Kentaro MURAYAMA, Kasugai-shi (JP)

Correspondence Address: BANNER & WITCOFF, LTD.;ATTORNEYS FOR CLIENT NO. 016689, 1100 13th STREET, N.W., SUITE 1200, WASHINGTON, DC, 20005-4051, US

(73) Assignee: Brother Kogyo Kabushiki Kaisha, Nagoya-shi (JP)

(21) Appl. No.: 12/558,913

(22) Filed: Sep. 14, 2009

(30) Foreign Application Priority Data
Sep. 26, 2008 (JP) 2008-248876

(51) Int. Cl. G03G 15/00

(52) U.S. Cl. 399/71

(57) ABSTRACT

An image forming apparatus includes: a carrier; an image forming unit configured to form an image on the carrier using colorant, the image including a pattern; a pattern sensor configured to detect the pattern formed on the carrier; a cleaner configured to perform cleaning of the carrier; and a residue sensor configured to perform detection of residual colorant remaining on the carrier after the cleaner performs the cleaning of the carrier. A detection condition for the residue sensor to perform the detection of the residual colorant is more suitable for detecting colorant than the detection condition for the pattern sensor to detect the pattern.

### CROSS REFERENCE TO RELATED APPLICATION

This application claims priority from Japanese Patent Application No. 2008-248876 filed Sep. 26, 2008. The entire content of this priority application is incorporated herein by reference.

### TECHNICAL FIELD

The present invention relates to an image forming apparatus. Specifically, the image forming apparatus includes a function of cleaning a carrier such as a belt and the like.

### BACKGROUND

An image forming apparatus including a function to form a pattern on a belt (a carrier) for conveying sheets, detect the pattern using a pattern sensor to measure a positional deviation of an image, and correct the positional deviation on a basis of the measurement result, is conventionally known. Such an apparatus includes a cleaner for collecting toner (colorant), paper powder, and the like adhered to the belt and performs cleaning of the belt with the cleaner after the pattern detection described above.

When the cleaning performance of the cleaner decreases, the sheets can be soiled with the toner remaining on the belt. In order to avoid this, there is a known art that, after the cleaning of the belt, a detection of the residual toner on the belt is performed using the pattern sensor in a manner identical with the pattern detection. With this art, the cleaning performance of the cleaner is determined and, if the cleaning performance is lower than a predetermined level, the user is requested to replace the cleaner with a new one.

However, there is a need in an image forming apparatus that can provide higher accuracy in detecting the colorant remaining on the belt.

### SUMMARY

An aspect of the present invention is an image forming apparatus including: a carrier; an image forming unit configured to form an image on the carrier using colorant, the image including a pattern; a pattern sensor configured to detect the pattern formed on the carrier; a cleaner configured to perform cleaning of the carrier; and a residue sensor configured to perform detection of residual colorant remaining on the carrier after the cleaner performs the cleaning of the carrier. A detection condition for the residue sensor to perform the detection of the residual colorant is suitable for detecting colorant than the detection condition for the pattern sensor to detect the pattern.

### BRIEF DESCRIPTION OF THE DRAWINGS

FIG. 1 is a side sectional view illustrating a schematic configuration of a printer of a first illustrative aspect in accordance with the present invention;

FIG. 2 is a block diagram schematically illustrating an electrical configuration of the printer;

FIG. 3 is a circuit diagram illustrating apart of a circuit configuration of a pattern sensor;

FIG. 4 is a flowchart illustrating a positional deviation detection process;

FIG. 5 is a flowchart illustrating a cleaning state measurement process;

FIG. 6 is a view illustrating a pattern for the positional deviation detection;

FIG. 7 is a graph illustrating an output of a light receiving circuit when the pattern is measured;

FIG. 8 is a graph illustrating an output of a light receiving circuit when the residual toner is measured;

FIG. 9 is a graph illustrating a relationship between a condition for cleaning a belt and a cleaning state;

FIG. 10 is a graph illustrating a relationship between a condition for cleaning the belt and a cleaning state;

FIG. 11 is a graph illustrating a relationship between a condition for cleaning the belt and a cleaning state; and

FIG. 12 is a flowchart illustrating a positional deviation detection process of a second illustrative aspect.

### DETAILED DESCRIPTION

<First Illustrative Aspect>

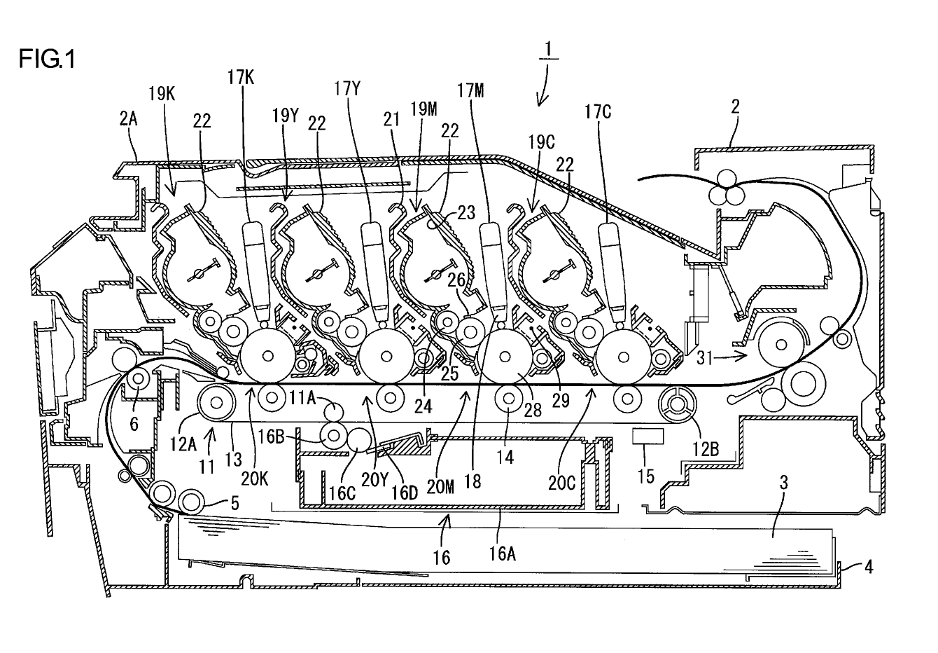

A first illustrative aspect in accordance with the present invention will hereinafter be described with reference to FIGS. 1 through 11.

(Schematic Configuration of Printer)

FIG. 1 is a side sectional view illustrating a schematic configuration of a printer 1 (an illustration of an image forming apparatus). The printer 1 is a direct tandem type color printer that can form images using toner of four colors (black K, yellow Y, magenta M, and cyan C). The left side in FIG. 1 represents the front side of the printer 1. Note that some of reference characters of identical components for different colors are omitted in FIG. 1.

The printer 1 includes a body casing 2, an openable cover 2A, a sheet tray 4, a sheet-feed roller 5, a registration roller pair 6, and a belt unit 11. The cover 2A is disposed on the top of the body casing 2. The sheet tray 4 is disposed in a bottom portion of the body casing 2 such that a plurality of sheets 3 (each sheet 3 is an illustration of a recording medium) can be stacked therein. The sheet-feed roller 5 is disposed above the front side of the sheet tray 4. As the sheet-feed roller 5 rotates, a sheet 3 stacked uppermost in the sheet tray 4 is sent toward the registration roller pair 6. The registration roller pair 6 corrects skew of the sheet 3 and, thereafter, conveys the sheet 3 onto the belt unit 11.

The belt unit 11 includes a belt support roller 12A disposed in a front side thereof, a belt drive roller 12B disposed in a rear side thereof, and a continuous loop belt 13 (an illustration of a carrier) stretched between the belt support roller 12A and the belt drive roller 12B. The belt 13 is made of resin such as polycarbonate, and its surface is mirror finished so as to have a high specular reflectance relative to its diffuse reflectance. Transfer rollers 14 are disposed in the loop of the belt 13 each at positions opposed to photosensitive drums 28 of respective process units 19K-19C (described below) via the belt 13. When the cover 2A of the body casing 2 is open and the process units 19K-19C are removed outward, the belt unit 11 can be installed in, or removed from, the body casing 2.

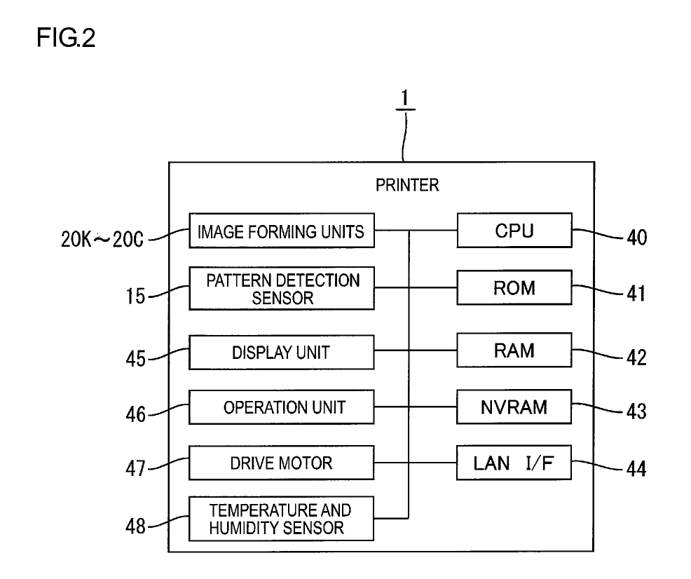

The belt drive roller 12B is connected via a gear mechanism (not illustrated) to a drive motor 47 (see FIG. 2) mounted in the body casing 2. When the drive motor 47 drives the belt drive roller 12B, the belt 13 circulates clockwisely in the figure, so that a sheet 3, which is electrostatically adsorbed on an upper surface of the belt 13, is conveyed rearwardly.

A pattern sensor 15 (an illustration of a pattern sensor and a residue sensor) is opposed to a lower and outer surface of the belt 13. The pattern sensor 15 can detect patterns and the like formed on the belt 13 (the pattern sensor 15 will be described below). Furthermore, a cleaner 16 is disposed below the belt unit 11. The cleaner 16 can perform cleaning of the belt 13 so as to collect the toner, paper powder, and the like adhered to the surface of the belt 13.

The cleaner 16 includes a box-shaped case 16A and a cleaning roller 16B disposed on the top of the case 16A. The cleaning roller 16B has a metal shaft and a foam material around the shaft. While a backup roller 11A made of metal is mounted to the belt unit 11, the cleaning roller 16B is opposed to the backup roller 11A via the belt 13. The backup roller 11A is urged toward the cleaning roller 16B, so that the belt 13 is held between the backup roller 11A and the cleaning roller 16B.

The cleaning roller 16B abuts against a collecting roller 16C made of metal, and the collecting roller 16C abuts against an edge of a blade 16D. The backup roller 11A is grounded, and a negative voltage is applied to the cleaning roller 16B. Thus, the toner, paper powder, and the like adhered to the belt 13 are physically scraped off and, along with this, are electrically drawn toward the cleaning roller 16B. In addition, a negative voltage higher than the voltage applied to the cleaning roller 16B is applied to the collecting roller 16C. Thus, the toner and the like adhered to the cleaning roller 16B are electrically drawn to the collecting roller 16C. Then, the toner and the like adhered to the collecting roller 16C are scraped off by the blade 16D and are accommodated in the case 16A.

Four exposure units 17K, 17Y, 17M, 17C and the process units 19K, 19Y, 19M, 19C are arranged in tandem above the belt unit 11. The exposure units 17K-17C, the process units 19K-19C, and the transfer rollers 14 configure four image forming units 20K, 20Y, 20M, 20C (each is an illustration of a forming unit), which respectively correspond to black, yellow, magenta, and cyan. Each of the image forming units 20K-20C can form an image (including a pattern) on the sheet 3 and on the belt 13 using toner.

The exposure units 17K-17C are supported by a lower surface of the cover 2A. Each of the exposure units 17K-17C includes a LED head 18 having a plurality of LEDs arranged in line on the bottom end thereof. At a time of exposure, the exposure units 17K-17C emit light from the respective LED heads 18 thereof to the surfaces of the respective photosensitive drums 28 under light emission control based on a data of the forming image.

Each of the process units 19K-19C includes a cartridge frame 21 and a developer cartridge 22 removably attached to the cartridge frame 21. When the cover 2A is opened, the exposure units 17K-17C are removed upwardly and outwardly following the cover 2A so as to allow each of the process units 19K-19C to be separately attached to, or removed from, the body casing 2.

Each developer cartridge 22 includes a toner chamber 23, a supply roller 24, a developer roller 25, a layer-thickness regulating blade 26, and the like. Each toner chamber 23 contains toner (developer) of one color. Toner released from the toner chamber 23 is supplied to the developer roller 25 by rotation of the supply roller 24 and is positively charged by friction between the supply roller 24 and the developer roller 25. Then, along with rotation of the developer roller 25, the toner enters between the layer-thickness regulating blade 26 and the developer roller 25. The toner is further charged by friction there and formed into a uniform thin layer.

Each of the cartridge frames 21 holds a photosensitive drum 28 and a charger 29 of a scorotron type. Each of the photosensitive drums 28 has a surface covered with a photosensitive layer having a positive charge property. At a time of image formation, the photosensitive drums 28 are rotationally driven and, the surfaces of the photosensitive drums 28 are uniformly and positively charged by the respective chargers 29. Then, the positively charged surfaces are exposed by scanning of the exposure units 17K-17C. Thus, an electrostatic latent image is formed on the surface of each of the photosensitive drum 28.

Next, the toner positively charged and carried on the developer roller 25 is supplied to the electrostatic latent image on the surface of the photosensitive drum 28, so that the electrostatic latent image is visualized as a toner image. While the sheet 3 passes through each of the positions in between the photosensitive drum 28 and the transfer roller 14, the toner images carried on the surfaces of the photosensitive drums 28 are transferred onto the sheet 3 one by one under the negative transfer voltage applied to the transfer rollers 14. Next, the sheet 3 carrying the toner image is conveyed to a fixing unit 31, where the toner image is fused. Thereafter, the sheet 3 is conveyed upwardly and is ejected onto a top surface of the cover 2A.

(Electrical Configuration of Printer)

FIG. 2 is a block diagram schematically illustrating an electrical configuration of the printer 1.

As illustrated in the same figure, the printer 1 includes a CPU 40 (an illustration of a changing unit, an adjusting unit, a determination unit, and an execution unit), a ROM 41, a RAM 42, an NVRAM (nonvolatile random access memory) 43 (an illustration of a storage), and a network interface 44. These members are connected to the image forming units 20K-20C, the pattern detection sensor 15, the cleaner 16, a display unit 45, an operation unit 46, the drive motor 47, a temperature and humidity sensor 48, and the like.

Programs for the printer 1 to execute processes (such as a positional deviation amount detection process, which will be described below) are stored in the ROM 41. The CPU 40 reads out the programs from the ROM 41 and, according to the programs, controls each unit while storing results of the process in the RAM 42 or the NVRAM 43. The network interface 44 can be connected to an external computer (not illustrated) via a communication line such that mutual data communication is available.

The display unit 45 includes a liquid crystal display, indicator lamps, and the like so as to display various setting windows, operating states of the printer 1, and the like. The operation unit 46 includes a plurality of buttons which enable a user to perform various input operations. The drive motor 47 drives the registration roller pair 6, the belt drive roller 12B, the cleaning roller 16B, the developer rollers 25, and the photosensitive drums 28 via gear mechanisms (not illustrated). The temperature and humidity sensor 48 can detect the ambient temperature and humidity and output respective detection signals.

(Pattern Sensor)

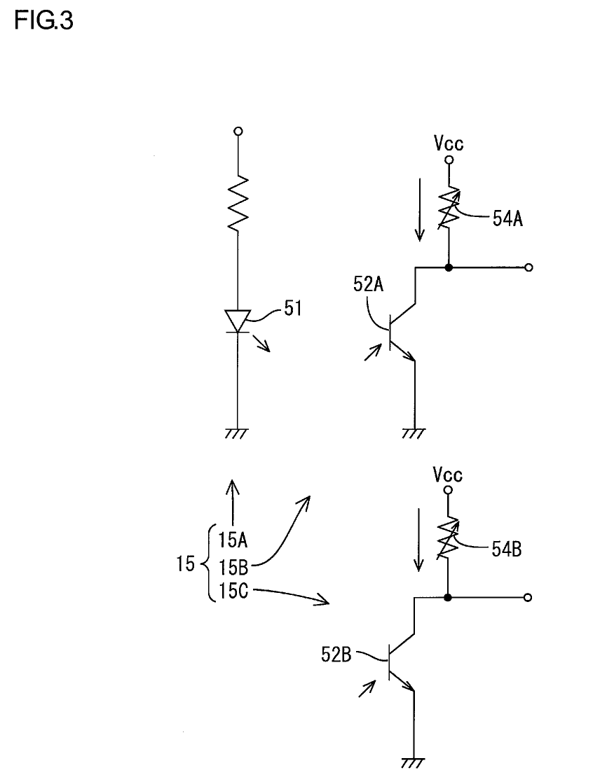

FIG. 3 is a circuit diagram illustrating a part of a circuit configuration of the pattern sensor 15.

The pattern sensor 15 includes a light emitting circuit 15A (an illustration of a light emitting unit) and two light receiving circuits 15B, 15C. The light emitting circuit 15A has a light emitting element 51 configured by LEDs. A voltage is applied to the light emitting circuit 15A under an instruction of the CPU 40 so that the light emitting element 51 emits light to the surface of the belt 13.

The light receiving circuits 15B, 15C are configured identically with each other. That is, the light receiving circuits 15B, 15C include light receiving elements 52A, 52B, respectively, and the light receiving elements 52A, 52B are configured by respective phototransistors. One of the light receiving elements 52A, 52B is a specular reflection light receiving element 52A that receives the specular reflection of the light emitted to the belt 13. The other one is a diffuse reflection light receiving element 52B that receives the diffuse reflection of the light emitted to the belt 13. The emitters of the light receiving elements 52A, 52B are grounded, while the collectors are connected to the power line Vcc via digital potentiometers 54A, 54B, respectively. In addition, output lines of the light receiving circuits 15B, 15C run from the collectors of the light receiving elements 52A, 52B, respectively. A current corresponding to an amount of received light flows between the collector and the emitter of each of the light receiving elements 52A, 52B.

The CPU 40 sets each of the resistance values of the digital potentiometers 54A, 54B within a predetermined range by writing set values to their registers. The ROM 41 stores a table indicating corresponding relationships between the set values to be supplied to the digital potentiometers 54A, 54B and the resistance values. When the resistance values of the digital potentiometers 54A, 54B are changed, sensitivities (each is an illustration of a detection condition) of the light receiving circuits 15B, 15C, respectively, are correspondingly changed. Note that each of the sensitivities refers to a ratio of a change in the output voltage relative to a change in the amount of received light. The output voltage of the light receiving circuits 15B, 15C are compared with respective threshold values set by the CPU in respective comparators (not illustrated), and the comparators output high/low signals to the CPU 40. Note that the outputs of the light receiving circuits 15B, 15C may be converted into digital values by respective AD converters and inputted to the CPU 40.

(Positional Deviation Detection Process)

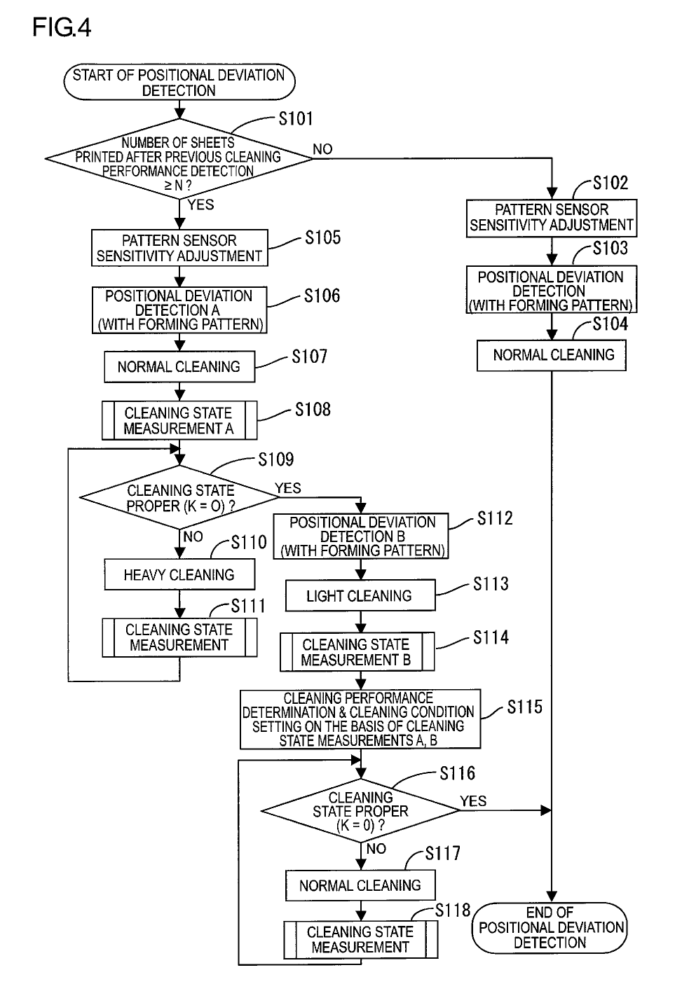

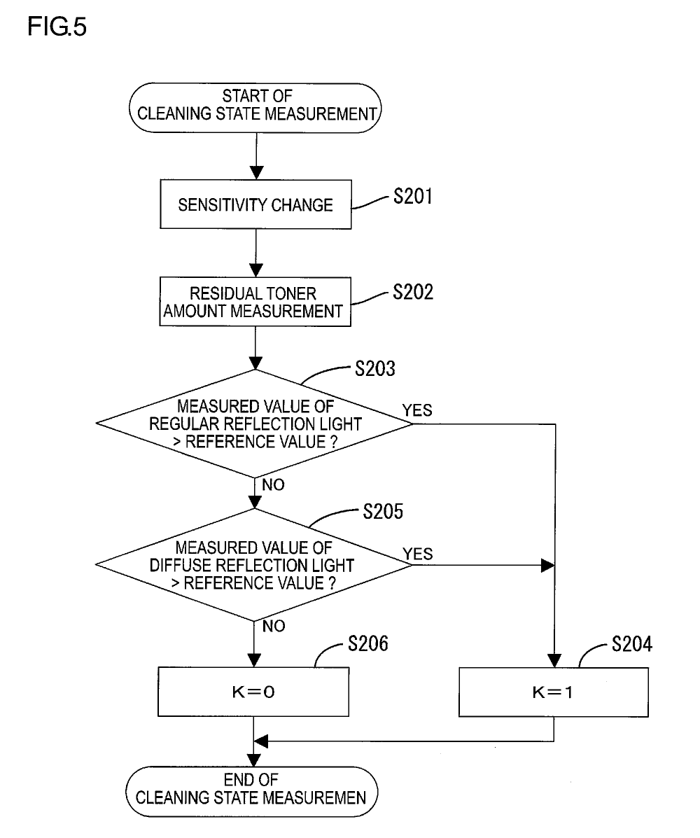

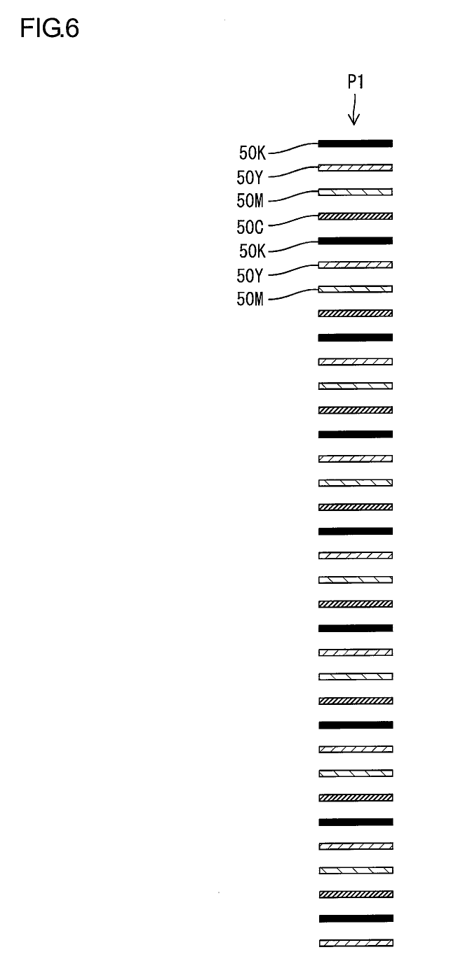

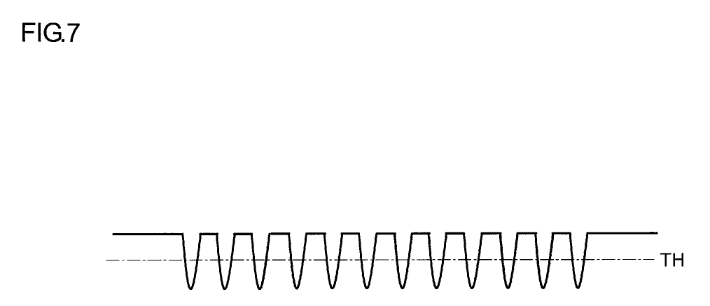

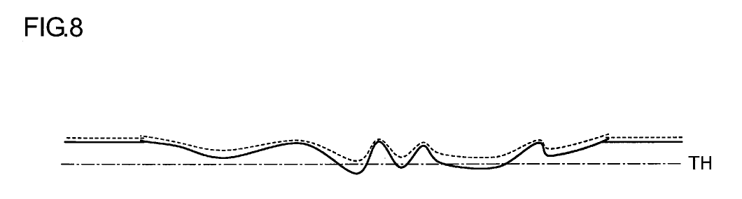

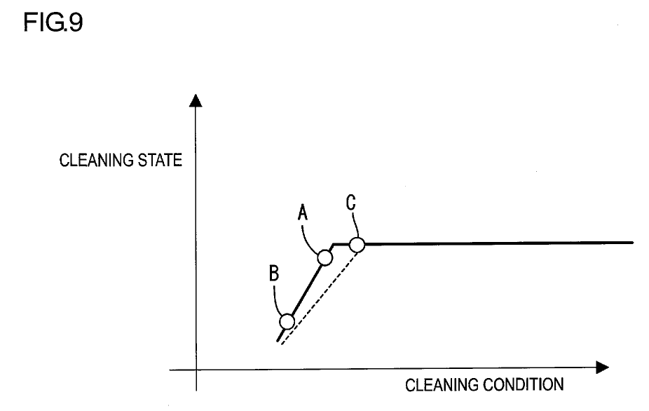

FIG. 4 and FIG. 5 are flowcharts illustrating the positional deviation detection process. FIG. 6 is an illustration of a pattern P1 for the positional deviation detection. FIG. 7 is a graph illustrating the output of the light receiving circuit 15B when the pattern P1 is measured, while FIG. 8 is a graph illustrating the output of the circuit 15B when the residual toner is measured. In addition, FIG. 9 through FIG. 11 are graphs illustrating relationships between conditions for cleaning the belt 13 and cleaning states.

The positional deviation detection process is executed under control of the CPU 40 when a predetermined condition is met, e.g. right after the power is turned on, when open-close of the cover 2A is detected, when a predetermined time has elapsed or a predetermined number of sheets has printed from a previous positional deviation detection process.

As illustrated in FIG. 4, when the positional deviation detection process starts, the CPU 40, first, determines whether the number of sheets printed after previous cleaning ability determination is equal to or larger than a positive integer N (S101). Note that the CPU 40 stores in the NVRAM 43 information required for this determination, such as the total number of sheets printed by the printer 1 and the number of printed sheets at the time of the latest cleaning ability determination.

Then, if the number of sheets printed after the previous cleaning ability determination is smaller than N (S101: No), the CPU 40 adjusts the sensitivity of the pattern sensor 15 (S102). The adjustment is performed with respect to each of the light receiving circuits 15B, 15C such as follows: while the belt 13 carrying no pattern is being driven, a threshold value level (a reference voltage value) to be supplied to the comparator is set to a predetermined reference value; while a resistance value of the digital potentiometer 54A (54B) is being stepwisely changed, the output of the light receiving circuit 15B (15C) when receiving the reflection light from the surface of the belt 13 is measured; thereafter, the resistance value of the digital potentiometer 54A (54B) where the high/low ratio in the output of the light receiving circuit 15B (15C) is substantially equal to 1 is calculated; and, on the basis of the calculated resistance value, the resistance value for the following positional deviation detection is determined (and is set). That is, in this step, on the basis of the level of the reflection light received from the surface of the belt 13, each of the sensitivities of the light receiving circuits 15B, 15C for detecting the positional deviation is determined.

Next, the CPU 40 forms the pattern P1 on the belt 13 using the image forming units 20K-20C and measures the pattern P1 using the pattern sensor 15 (S103). As illustrated in FIG. 6, the pattern P1 has a plurality of mark sets each having four (black, yellow, magenta, and cyan, arranged in this order) marks 50K-50C. Each of the marks 50K, 50Y, 50M, 50C is elongated in the main scanning direction (the widthwise direction of the belt 13). The plurality of mark sets are arranged with intervals in the vertical scanning direction (the moving direction of the belt 13) over the entire circumference of the belt 13. If the marks 50K-50C are formed at ideal positions without any positional deviation, the intervals between adjacent marks 50K-50C are equal to each other.

FIG. 7 illustrates the output of the light receiving circuit 15B (having the specular reflection light receiving element 52A) when the pattern P1 is measured. Because the specular reflectance of each of the marks 50K-50C is lower than the specular reflectance of the surface of the belt 13, the output of the light receiving circuit 15B turns from high to low as illustrated in the same figure when each of the marks 50K to 50C reaches the detection position of the pattern sensor 15. The CPU 40 measures time points where the output of the light receiving circuit 15B turns from high to low and, on the basis of the measurement result, calculates each of positional deviation amounts of the marks 50Y, 50M, 50C (marks of three object colors) based on the position of the respective black marks 50K (marks of a reference color) in the vertical scanning direction. Thereafter, the CPU 40 averages the positional deviation amounts of all mark sets with respect to each object color. Then, while a positional deviation correction value for each object color is stored in the NVRAM 43 and the like, the CPU 40 adds a value that compensates the average of the positional deviation amount to the positional deviation correction value for each object color. The positional deviation correction values are thus updated.

Note that the pattern P1 is measured also on the basis of the output of the light receiving circuit 15C (having the diffuse reflection light receiving element 52B). The diffuse reflectance of each of the marks 50Y, 50M, 50C in each color other than black is higher than the diffuse reflectance of the surface of the belt 13 and the black marks 50K. Accordingly, when the marks 50Y, 50M, 50C other than the black marks 50K reach the detection position of the pattern sensor 15, the output of the light receiving circuit 15C turns from low to high. Because the measurement is thus performed on the basis of the outputs of the two different light receiving circuits 15B, 150, false detection under the influence of noise and the like can be reduced, and higher accuracy can be achieved.

Next, the CPU 40 performs a normal cleaning of the belt 13 using the cleaner 16 (S104). Note here that the CPU 40 can determine set values of one or more cleaning conditions for performing the normal cleaning and other kinds of cleanings, store those set values in the NVRAM 43, and set the cleaning conditions for the cleanings according to the set values. The cleaning conditions that the CPU 40 can set for the cleanings are, for example, the number of rotations of the belt 13, the driving speed of the belt drive roller 12B for the belt 13, the bias voltage level applied to the cleaning roller 16B, the speed of revolution of the cleaning roller 16B, the strength of stress of the cleaning roller 16B and the backup roller 11A against the belt 13, and the like. The CPU 40 can set anyone or more of these cleaning conditions.

Under the cleaning conditions for the normal cleaning, unless the cleaning ability of the cleaner 16 has not decreased, the cleaner 16 can remove the toner on the belt 13 to a desired level. The CPU 40 reads out the cleaning conditions for the normal cleaning from the NVRAM 43 and, under the conditions, cleans the belt 13 to remove the pattern P1 formed on the belt 13. Then the CPU 40 completes the positional deviation detection process.

On the other hand, if the number of sheets printed after the previous cleaning ability determination is equal to or larger than N (S101: Yes), the CPU 40 adjusts the sensitivity of the pattern sensor 15 (S105) similar to S102 and, successively, performs a positional deviation detection A (S106). In the positional deviation detection A, the CPU 40 forms a pattern having a half length of the pattern P1 on the belt 13 and measures the positional deviation amount with respect to each object color. Thereafter, the CPU 40 performs the normal cleaning of the belt 13 (S107) similar to S104.

Next, the CPU 40 performs a cleaning state measurement A (an illustration of one of a plurality of measurement operations) for determining the cleaning state of the belt 13 (S108). More specifically, in the cleaning state measurement A, the CPU 40 measures the amount of the residual toner on the belt 13 and determines the cleaning state on the basis of the amount. In this cleaning state measurement A, as illustrated in FIG. 5, the CPU 40 changes the resistance values of the digital potentiometers 54A, 54B (S201) so that the sensitivities of the receiving circuits 15B, 15C are set to be more suitable for detecting the residual toner on the belt 13. Then, while driving the belt 13, the CPU 40 measures the amount of the residual toner on the belt 13 on the basis of the outputs of the light circuit receiving circuits 15B, 15C and determines the cleaning state (S202).

Suppose here that the measurement of the residual toner is performed using alone the light receiving circuit 15B (having the specular reflection light receiving element 52A) without changing its sensitivity after the measurement of the pattern Pl. Then, because the density of the residual toner is less than that of the marks 50K-50C of the pattern P1, the output can be such that as illustrated by a dotted line in FIG. 8, where few residual toner is detected.

On the other hand, in this illustrative aspect, the sensitivity of the light receiving circuit 15B is increased so that the output wave is changed to a one as illustrated by a solid line in FIG. 8, the residual toner can be detected with higher accuracy. Note that, in this illustrative aspect, the high/low ratio of the output is assumed to be a measured value that indicates the amount of the residual toner. Furthermore, because the sensitivity of the light receiving circuit 15C (having the diffuse light receiving element 52B) is decreased when measuring the residual toner, the residual toner other than black can be measured with higher accuracy.

Thereafter, the CPU 40 determines whether the measured value obtained by the light receiving circuit 15B (having the specular reflection light receiving element 52A) exceeds a predetermined reference value (S203). If the measured value exceeds the reference value (S203: Yes), the CPU 40 sets 1 to a flag K (S204) so as to indicate that the cleaning state does not reach a proper level, and completes the cleaning state measurement A. On the other hand, if the measured value obtained by the light receiving circuit 15B does not exceed the reference value (S203: No), the CPU 40 determines whether the measured value obtained by the light receiving circuit 15C (having the diffuse reflection light receiving element 52B) exceeds another reference value (S205). If the measured value obtained using the light receiving circuit 15C exceeds the reference value (S205: Yes), the process goes to S204 to set 1 to the flag K. On the other hand, if the measured value obtained by the light receiving circuit 15C does not exceed the reference value (S205: No), the CPU 40 sets 0 (zero) to the flag K (S206) and completes the cleaning state measurement A.

After performing the cleaning state measurement A in S108 in FIG. 4, the CPU 40 determines from the value of the flag K whether the cleaning state is at the proper level (S109). If the cleaning state does not reach the proper level, i.e. if the value of the flag K is 1 (S109: No), the CPU 40 executes a heavy cleaning (S110) of the belt 13. In the heavy cleaning, the cleaning conditions are adjusted so that the cleaning performance is higher than that in the normal cleaning.

More specifically, in the heavy cleaning, the cleaning performance is enhanced than that in the normal cleaning by changing the cleaning conditions as follows: the number of circulation of the belt 13 is increased; the driving speed of the belt 13 is decreased; the bias voltage applied to the cleaning roller 16B is raised; the stress of the cleaning roller 163 against the belt 13 is raised; the speed of revolutions of the cleaning roller 16B is increased; and the like. Note that the CPU 40 may change anyone or more of these cleaning conditions. Thereafter, the CPU 40 performs a cleaning state measurement (S111) similar to the cleaning state measurement A of S108, returns to S109 to determine whether the cleaning state is at the proper level, and repeats the similar process until the cleaning state reaches the proper level.

When the cleaning state of the belt 13 has reached the proper level (S109: Yes), the CPU 40 performs a second positional deviation detection B (S112). In the positional deviation detection B, the CPU 40 forms the pattern having a half length of the pattern P1 on the belt 13, measures the pattern, and calculates a positional deviation correction value with respect to each color by averaging the measurement result of the positional deviation detection B and that of the positional deviation detection A. Then, the CPU 40 updates positional deviation correction values stored in the NVRAM 43.

Subsequently, the CPU 40 executes a light cleaning of the belt 13 (S113). In the light cleaning, the cleaning conditions are adjusted so that the cleaning performance is lower than that in the normal cleaning. More specifically, at the time of the light cleaning, the cleaning performance is decreased by changing the cleaning conditions as follows: the number of circulation of the belt 13 is decreased, the driving speed of the belt 13 is increased, the level of the bias voltage applied to the cleaning roller 16B is decreased, the stress of the cleaning roller 16B against the belt 13 is reduced, the speed of revolutions of the cleaning roller 16B is decreased, and the like.

Thereafter, the CPU 40 executes a cleaning state measurement B (an illustration of one of the plurality of measurement operations) (S114) similar to S108. Subsequently, on the basis of the results of the cleaning state measurement A and the cleaning state measurement B, the CPU 40 performs a cleaning ability determination for the cleaner 16 and sets the cleaning conditions (S115).

Note here that FIG. 9 through FIG. 11 are graphs illustrating the relationships between the cleaning condition and the cleaning state. In FIG. 9 through FIG. 11, the cleaning condition is better for cleaning the residual toner on the right hand side. For example, where “the number of rotations of the belt 13 at the time of cleaning” is used as the cleaning condition, the number of rotations of the belt 13 is larger on the right hand side.

As illustrated in these figures, as the cleaning condition becomes better, the cleaning state level rises (the amount of the residual toner decreases) up to a certain point. Note that the slope of the line varies depending on the cleaning ability of the cleaner 16. That is, the slope becomes lower as the cleaning ability decreases. Therefore, as illustrated by a dotted line in FIG. 9, the cleaning state level can vary among the cleanings performed under the identical cleaning conditions. On the other hand, where the cleaning condition exceeds the certain point, the cleaning state level is substantially constant. In other words, the cleaning state is at the proper level where most of the residual toner is removed.

As illustrated in FIG. 9, in a case where both of the results of the cleaning state measurements A, B (indicated by points A, B, in the figure) indicates that the cleaning state has not reached the proper level, the CPU 40 calculates the cleaning condition at a point C where the cleaning condition is better than the cleaning condition A for the normal cleaning. Then, the CPU 40 sets the calculation result as the cleaning condition for the normal cleaning. Note here that the cleaning condition at the point C is ideally that of a minimum level where the cleaning state is surely at the proper level. Thus, because the cleaning condition is set to the point C, the proper cleaning performance will be provided in later normal cleanings.

Furthermore, in this case, the deteriorating state of the cleaner 16 can be determined by comparing the slope of the line connecting the points A, B with a predetermined reference value. Using this determination result, the CPU 40 can display information (such as whether the cleaner 16 is a new one or a used one, whether it is a replacement time for the cleaner 16, when an expected time for the replacement is, and the like) on the display unit 45 to notify the user. Thus, because the setting of the cleaning conditions for the normal cleaning and the determination of the cleaning ability are performed on the basis of the results of the plurality of cleaning state measurements, higher accuracy in the setting and the determination can be achieved.

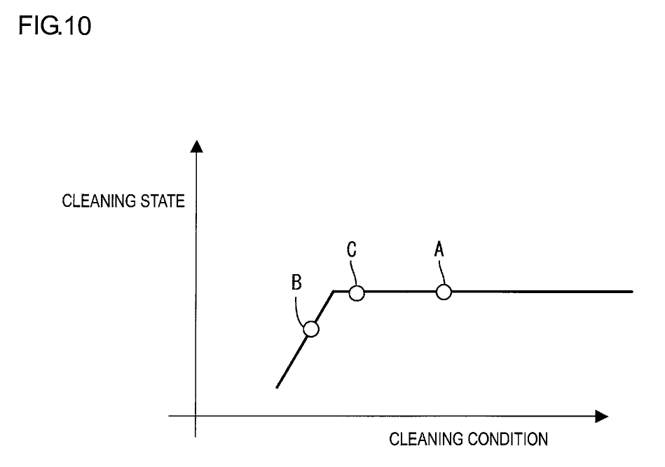

On the other hand, as illustrated in FIG. 10, in a case where only the cleaning state measured by the cleaning state measurement A has reached the proper level, the CPU 40 calculates the cleaning condition at the point C on the basis of the cleaning condition for the cleaning state measurement B. Then, the CPU 40 sets the calculated condition as the cleaning condition for the normal cleaning. In this case, the slope of the line cannot be calculated from the measurement results. Accordingly, instead, the CPU 40 may estimate the slope (i.e. the cleaning ability of the cleaner 16) on the basis of, for example, an amount of usage of the cleaner 16 (the number of sheets printed after a new cleaner 16 is installed) and, on the basis of the estimated slope, calculate the cleaning condition at the point C. Note that, in this case, the cleaning condition at the point C is equal to or lower than the cleaning condition at the point A.

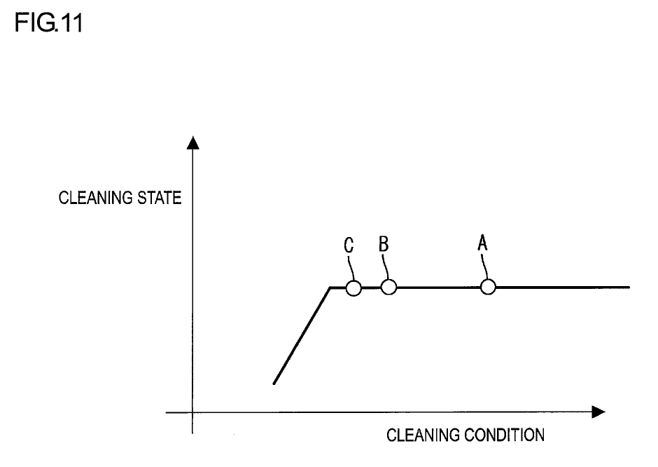

Further, as illustrated in FIG. 11, in a case where both of the cleaning states measured by the cleaning state measurements A, B have reached the proper level, the CPU 40 calculates the cleaning condition at the point C on the basis of the cleaning condition at the point B and sets the calculated condition as the cleaning condition for the normal cleaning. In this case, the cleaning condition at the point C is equal to or lower than the cleaning condition at the point B. Note that, usually, the cleaning ability of the cleaner 16 is not widely improved where an identical cleaner 16 is continuously used. Accordingly, in this case, the CPU 40 may determine that the cleaner 16 has been replaced with a new one and reset a value (stored in the NVRAM 43 and the like) of the amount of usage of the cleaner 16 (the number of sheets printed after the replacement with the new one).

Now referring back to the process of the positional deviation detection, after performing the cleaning ability determination and the setting of the cleaning condition in S115 in FIG. 4, the CPU 40 determines whether the cleaning state of the belt 13 is at the proper level (S116). If the cleaning state is not at the proper level, i.e. if the value of the flag K is (S116: No), the CPU 40 executes the normal cleaning (S117). Thereafter, the CPU 40 executes the cleaning state measurement (S118) and, thereafter, returns to S116 to determine the cleaning state again. The similar process is repeated until the cleaning state reaches the proper level. If the cleaning state is at the proper level (S116: Yes), CPU 40 completes this positional deviation detection process.

(Functions of First Illustrative Aspect)

Functions of this illustrative aspect will now be described. After cleaning the belt 13 using the cleaner 16, the detection of the residual toner is performed under the condition that is more suitable for detecting toner than the detection condition for detecting the pattern P1 with the pattern sensor 15. This results in higher accuracy in detecting the residual toner. In contrast, the detection of the pattern P1 can be performed under the condition that the pattern sensor 15 does not detect the residual toner having a comparatively low density, so that the influence of noise due to the residual toner and the scratches on the belt 13 can be reduced. This results in higher accuracy in detecting the pattern P1.

Furthermore, the pattern sensor 15 and the residue sensor include the shared light receiving elements 52A, 52B and the shared light receiving circuits 15B, 15C. Therefore, in comparison with a case where these sensors are configured separately from each other, the cost can be saved, and the apparatus can be downsized.

Furthermore, the sensitivity of the pattern sensor 15 for detecting the residual toner is changed to be more suitable for detecting toner than the sensitivity for detecting the pattern P1. This provides higher accuracy in detecting the residual toner.

Furthermore, the pattern sensor 15 includes the specular reflection light receiving element 52A and the diffuse reflection light receiving element 52B and performs the detection on the basis of both of the amounts of the light received by the light receiving elements 52A, 52B. This results in a proper detection even if the color and the density of the toner remaining on the belt 13 are various.

Furthermore, the residual toner remaining on the belt 13 is detected using the pattern sensor 15, and the cleaning condition is adjusted on the basis of the detection result. That is, when a large quantity of toner is detected on the belt 13, the cleaning condition is adjusted to enhance the cleaning performance of the cleaner 16. This results in the proper cleaning performance.

Furthermore, a plurality of the detections of the residual toner after cleaning the belt 13 are performed with changing the cleaning condition and, on the basis of the detection results, the cleaning ability of the cleaner 16 is determined. This results in grasping the performance of the cleaner 16 with higher accuracy. Thus, for example, the cleaning condition can be adjusted in accordance with the cleaning ability of the cleaner 16, and the replacement time for the cleaner 16 can be determined and notified to the user.

Furthermore, it is determined as to whether the change in state (increase in the number of printed sheets) after the previous toner detection meets the predetermined condition and, when the change meets the condition, the detection of the residual toner is executed. This results in the detection of the residual toner executed at suitable timings.

<Second Illustrative Aspect>

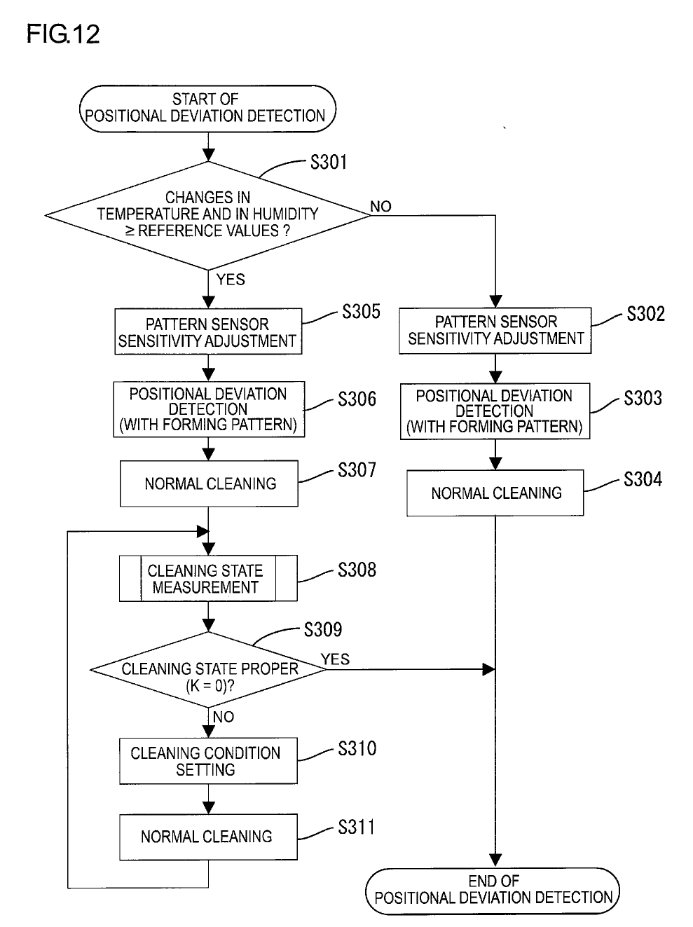

A second illustrative aspect in accordance with the present invention will now be described with reference to FIG. 12. FIG. 12 is a flowchart illustrating a positional deviation detection process. Note that, in this illustrative aspect, the configuration similar to the configuration of the first illustrative aspect will be designated with same reference characters, while the descriptions will be omitted.

When the positional deviation detection process as illustrated in FIG. 12 starts, the CPU 40 detects the current temperature and the current humidity using the temperature and humidity sensor 48, compares the current temperature and the current humidity with the temperature and the humidity, respectively, detected in the previous positional deviation detection process. Then, the CPU 40 determines whether the changes in temperature and in humidity are equal to or greater than respective reference values (S301). Note that the CPU 40 stores the temperature and the humiditie detected in the previous positional deviation detection process in the NVRAM 43 so as to perform the foregoing determination.

Thereafter, if both of the changes in temperature and in humidity are less than the respective reference values (S301: No), the CPU 40 adjusts the sensitivity of the pattern sensor 15 (S302), forms the pattern P1 on the belt 13, and performs the positional deviation detection (S303). Then, the CPU 40 performs the normal cleaning of the belt 13 to remove the pattern P1 (S304) and, thereafter, completes this positional deviation detection process.

On the other hand, if at least one of the changes in temperature and in humidity is greater than the respective reference value (S301: Yes), the CPU 40, similarly to S302-S304, executes the adjustment of the sensitivity of the pattern sensor 15, the positional deviation detection, and the normal cleaning of the belt 13 (S305, S306, S307). Then, the CPU 40 measures the cleaning state of the belt 13 (S308). If the cleaning state of the belt 13 is not at the proper level (S309: Yes), the CPU 40 changes the setting of the cleaning conditions so as to enhance the cleaning performance in the normal cleaning (S310). Then, the CPU 40 performs the normal cleaning of the belt 13 (S311) and returns to S308 to measure the cleaning state. If the cleaning state is not at the proper level, the similar process is repeated. If the cleaning state is at the proper level (S309: Yes), the CPU 40 completes this positional deviation detection process.

As described above, with this illustrative aspect, the determination is made as to whether the change in the states (the change in temperature or the change in humidity) detected after the previous toner detection meets the predetermined condition and, when the change meets the predetermined condition, the detection of the residual toner is executed. This results in execution of the detection of the residual toner at suitable timings.

Furthermore, because the cleaning performance can change in accordance with the change in temperature or in humidity, the cleaning condition is set on the basis of these changes. This results in the suitable cleaning performance.

<Other Illustrative Aspects>

The present invention is not limited to the illustrative aspects described above with reference to the drawings. For example, the illustrative aspects as follows are also included within the scope of the invention.

(1) In the above illustrative aspects, at the time of performing the cleaning state measurement, the sensitivity of the pattern sensor is adjusted by changing the resistance values of the digital potentiometers. The present invention is not limited to this. For example, the amount of the light emitted from the light emitting element to the belt may be changed, or the threshold value of the light receiving circuit may be changed.

(2) In the above illustrative aspects, the pattern sensor is combined with the residue sensor for detecting residual toner. In accordance with the present invention, the residual sensor may be provided separately from the pattern sensor.

(3) In the above illustrative aspects, the present invention is illustratively adopted to the printer of the direct tandem type. The present invention may be adopted also to an image forming apparatus of the other types such as a printer of intermediate transfer type, an inkjet printer, and the like. Furthermore, in the above illustrative aspects, the belt for conveying sheets is used as the carrier whereon the pattern is formed. In accordance with the present invention, the other members (such as the photosensitive drums, an intermediate transfer belt, and the like) may be used as the carrier.

What is claimed is:

1. An image forming apparatus comprising:
a carrier;
an image forming unit configured to form an image on the carrier using colorant, the image including a pattern;
a pattern sensor configured to detect the pattern formed on the carrier;
a cleaner configured to perform cleaning of the carrier; and
a residue sensor configured to perform detection of residual colorant remaining on the carrier after the cleaner performs the cleaning of the carrier,
wherein a detection condition for the residue sensor to perform the detection of the residual colorant is more suitable for detecting colorant than the detection condition for the pattern sensor to detect the pattern.

2. The image forming apparatus according to claim 1, wherein:
the pattern sensor and the residue sensor include a shared light receiving element and a shared light receiving circuit;
the light receiving element receives light reflected from the carrier; and
the light receiving circuit outputs a signal according to an amount of the light received by the light receiving element.

3. The image forming apparatus according to claim 2 further comprising a changing unit, wherein:
the detection condition includes a sensitivity; and
the changing unit changes the sensitivity for the residue sensor to perform the detection of the residual colorant to be suitable for detecting colorant than the sensitivity for the pattern sensor to detect the pattern.

4. The image forming apparatus according to claim 1, wherein:
the residue sensor includes a light emitting unit, a specular reflection light receiving element, and a diffuse reflection light receiving element;
the light emitting unit emits light to the carrier;
the specular reflection light receiving element receives specular reflection of the light emitted to the carrier;
the diffuse reflection light receiving element receives diffuse reflection of the light emitted to the carrier; and
the residue sensor performs the detection on a basis of an amount of the light received by the light receiving elements.

5. The image forming apparatus according to claim 1 further includes an adjusting unit, wherein:
the adjusting unit adjusts a cleaning condition for the cleaner to perform the cleaning on a basis of a result of the detection performed by the residue sensor.

6. The image forming apparatus according to claim 1 further includes a determination unit, wherein:
the cleaner performs the cleaning of the carrier under a cleaning condition;
the cleaner and the residue sensor perform a plurality of measurement operations to obtain a detection result, each of the plurality of measurement operations including the cleaning performed by the cleaner and the detection performed by the residue sensor after the cleaning is performed;
the determination unit changes the cleaning condition for the cleaner to perform the cleaning in each of the plurality of measurement operations; and
the determination unit determines a cleaning ability of the cleaner on the basis of the detection results.

7. The image forming apparatus according to claim 1 further comprising:
a storage configured to store information related to a state at a time of detection of the residual colorant performed by the residue sensor; and
an executing unit configured to determine whether a change in the state from the time of the detection of the residual colorant meets a predetermined condition on a basis of the information stored in the storage, and upon determination that the change meets the predetermined condition, the executing unit executes the detection of the residual colorant.
